(19) United States
(12) Patent Application Publication
(10) Pub. No.: US 2020/0211082 A1
(43) Pub. Date: Jul. 2, 2020

(54) METHODS AND SYSTEM FOR PRODUCT FRAME GUIDED PRODUCER-BUYER PLATFORM INTERACTIONS

(71) Applicant: Amela Kovacevic, Sammamish, WA (US)

(72) Inventors: Amela Kovacevic, Sammamish, WA (US); Selma Lupic, Sarajevo (BA); Selma Jakic, Sarajevo (BA)

(73) Assignee: Amela Kovacevic, Sammamish, WA (US)

(21) Appl. No.: 16/732,334

(22) Filed: Jan. 1, 2020

Related U.S. Application Data
(60) Provisional application No. 62/787,728, filed on Jan. 2, 2019.

(51) Int. Cl. G06Q 30/06; G06Q 30/02; G06Q 10/08

(52) U.S. Cl. CPC G06Q 30/0629; G06Q 30/0283; G06Q 10/087; G06Q 30/0643; G06Q 30/0631

(57) ABSTRACT

The present invention is a computer program product for grouping products, the computer program product comprising: one or more computer readable storage media and program instructions stored on the one or more computer readable storage media, the program instructions comprising: program instructions to create a product frame, wherein the creation of the product frame includes assigning a set of criteria to the product frame; program instructions to receive a set of product elements, wherein the product elements are assigned a set of parameters; program instructions to identify which product elements meet the set of criteria of the product frame based on the product element's set of parameters; program instructions to group the approved identified product elements within the product frame, wherein a product item is created; program instructions to store the product item.

### CROSS-REFERENCE TO RELATED APPLICATIONS

This application is a continuation-in-part (and claims the benefit of priority under 35 USC 120) of U.S. application No. 62/787,728/044,817 filed Jan. 2, 2019 now abandoned. The disclosure of the prior applications is considered part of (and is incorporated by reference in) the disclosure of this application.

### BACKGROUND

This disclosure relates generally to marketplace innerworkings and interactions for product/inventory categorization, product/inventory management, and more specifically to a method, computer program and computer system for establishing product/inventory management. How the system creates categories, how the producer selects to participate in product categories and how they add and create own product items that satisfy product category requirements. and selection of product(s) for a consumer, based on consumer's request, and how the consumer views and accesses the product/inventory.

Online stores have become a replacement for many shoppers who find it easier and more convenient to shop online. One type of these stores is e-commerce online store or homogenic online marketplaces. These online stores have organized their products similar to the actual stores, grouping goods/products by department and categories. Each good or product is classified differently based on the marketplace. Homogenic online marketplaces (e.g. Nordstrom®) are in control of the products they sell, the organization of the products, and representation of the products, and the visual design and feel of the marketplace. This is beneficial because the homogenic marketplace is able to easily control the products and presentation to the consumers. But still, even in this type of marketplace, the consumer is often overloaded with choices. A simple search for “men's shoes” will return thousands of different products. While there are filter to select shoes based on type, brand, color, etc., a consumer is still left with many products and must guess and figure out on its own if that particular shoes pairs well with other clothing items for a particular occasion or look.

Another type of online stores is so called multi-sided marketplaces. A product provided may be actual products (e.g. a toy sold by third party and fulfilled by Amazon) or a service (e.g. Uber—getting a ride). The multi-sided marketplace provides one location where multiple independent companies or independent individual producers are able to offer their products or services. The multi-sided marketplace provides a simple location for the consumer to search through multiple producers. While multi-sided marketplaces offer theoretically an endless variety, as they allow dynamic on-demand for many producers to join the platform. The problem of consumer choice overload and inconsistent and inadequate product categorization, organization and offering become even more aggregating here. Multi-sided marketplaces have to categorize and maintain a high volume of goods/products from a variety of producers, and with a variety of information provided related to the products. The various producers may describe similar items in different ways, having different meanings to different sizes and colors, and the like. This creates an issue for the consumer who has to do additional work to make sure their purchase is exactly what they expect it to be. Such unoptimized management requires additional processing and analysis, which are pushed down to the consumer. If the products are not organized effectively, the consumer experiences choice overload resulting in “choice paralysis” and is presented with overwhelming and ineffective exposure to the products. This likely results in the consumer searching elsewhere for the specific item(s). The management also works with merely keeping the goods and products organized to the consumer, that they are unable to address a question many consumers, which is,

Therefore, it is desired for a method, computer program, or computer system to properly categorize producer's goods, and present the goods or services to the producer in a method and manner that is more direct to the consumers request. Providing a shopping experience similar to visiting boutique shops with helpful staff but on a mass scale.

### SUMMARY

In a first embodiment, the present invention is a method for grouping products, the method comprising: identifying, by one or more processors, a product frame, wherein the product frame is comprised of a set of criteria; selecting, by one or more processors, the requirements for the product frame based on the set of criteria; receiving, by one or more processors, a set of product elements; grouping, by one or more processors, the set of product elements within the product frame's set of criteria, wherein the product item is created; storing, by one or more processors, the product item.

In a second embodiment, the present invention is a computer program product for grouping products, the computer program product comprising: one or more computer readable storage media and program instructions stored on the one or more computer readable storage media, the program instructions comprising: program instructions to create a product frame, wherein the creation of the product frame includes assigning a set of criteria to the product frame; program instructions to receive a set of product elements, wherein the product elements are assigned a set of parameters; program instructions to identify which product elements meet the set of criteria of the product frame based on the product element's set of parameters; program instructions to group the approved identified product elements within the product frame, wherein a product item is created; program instructions to store the product item.

In a third embodiment, the present invention is a computer system for grouping products, the system comprising: one or more computer processors, one or more computer readable storage media, and program instructions stored on the one or more computer readable storage media for execution by, at least one of the one or more processors, the program instructions comprising: program instructions to receive a set of product elements from a user; program instructions to identify a set of product frames based on the product elements; program instructions to present the set of product frames to a user; program instructions to receive a portion of the set of products to be input into the a product frame program instructions to confirm the completion of a set of requirements for the product frame, wherein a product item is formed program instructions to publish the product item.

### BRIEF DESCRIPTION OF THE DRAWINGS

Referring now to the drawings in which like reference numbers represent corresponding parts throughout:

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 depicts a block diagram depicting a computing environment according to an embodiment of the present invention.

FIG. 5 depicts a flowchart of the operational steps taken by a program, in accordance with an embodiment of the present invention.

FIG. 6 depicts a flowchart of the operational steps taken by a program, in accordance with an embodiment of the present invention.

FIG. 7 depicts a flowchart of the operational steps taken by the program, in accordance with an embodiment of the present invention.

FIG. 8 depicts an illustration of a user interface, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects may generally be referred to herein as a “circuit,” “module”, or “system.” Furthermore, aspects of the present invention may take the form of a computer program product embodied in one or more computer readable medium(s) having computer readable program code/instructions embodied thereon.

The present invention provides the benefit of a consumer having a team assist them in researching, customizing, and locating the proper product(s) based on the producer's initial request. This invention sets about to systematize and automate the benefits of high-tech business and product innovation, so that consumer can be presented with exactly the type of products they need based on their request. The present invention creates a marketplace for a consumer to locate, select, and purchase product(s) that are specifically geared or directed towards their request, in an appealing and easy to navigate system.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user computer, partly on the user computer, as a stand-alone software package, partly on the user computer and partly on a remote computer or entirely on the remote computer or server. In the latter scenario, the remote computer may be connected to the user computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud user can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple users using a multi-tenant model, with different physical and virtual resources dynamically assigned and reassigned according to demand. There is a sense of location independence in that the user generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the user, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and user of the utilized service.

Service Models are as follows:

Software as a Service (SaaS): the capability provided to the user is to use the provider's applications running on a cloud infrastructure. The applications are accessible from various client devices through a thin client interface such as a web browser (e.g., web-based e-mail). The user does not manage or control the underlying cloud infrastructure including network, servers, operating systems, storage, or even individual application capabilities, with the possible exception of limited user-specific application configuration settings.

Platform as a Service (PaaS): the capability provided to the user is to deploy onto the cloud infrastructure user-created or acquired applications created using programming languages and tools supported by the provider. The user does not manage or control the underlying cloud infrastructure including networks, servers, operating systems, or storage, but has control over the deployed applications and possibly application hosting environment configurations.

Infrastructure as a Service (IaaS): the capability provided to the user is to provision processing, storage, networks, and other fundamental computing resources where the user is able to deploy and run arbitrary software, which can include operating systems and applications. The user does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

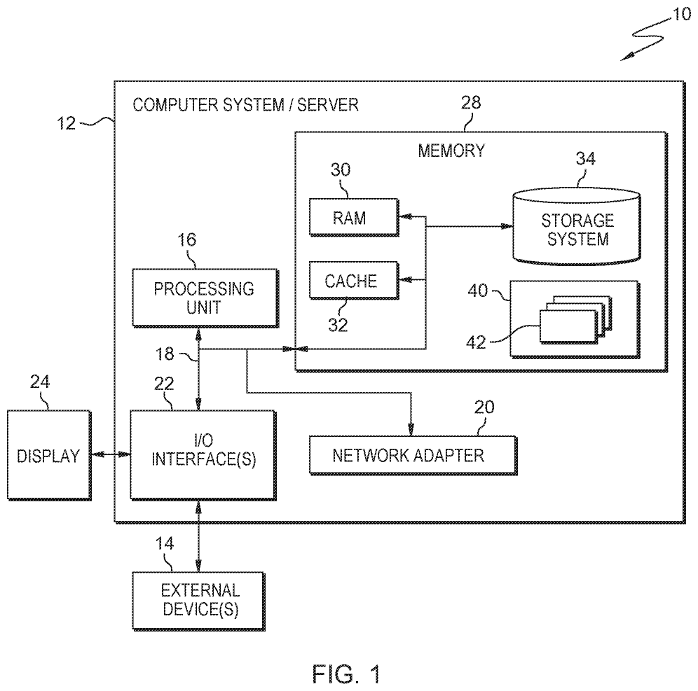

Referring now to FIG. 1, a schematic of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin client, thick client, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 100 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

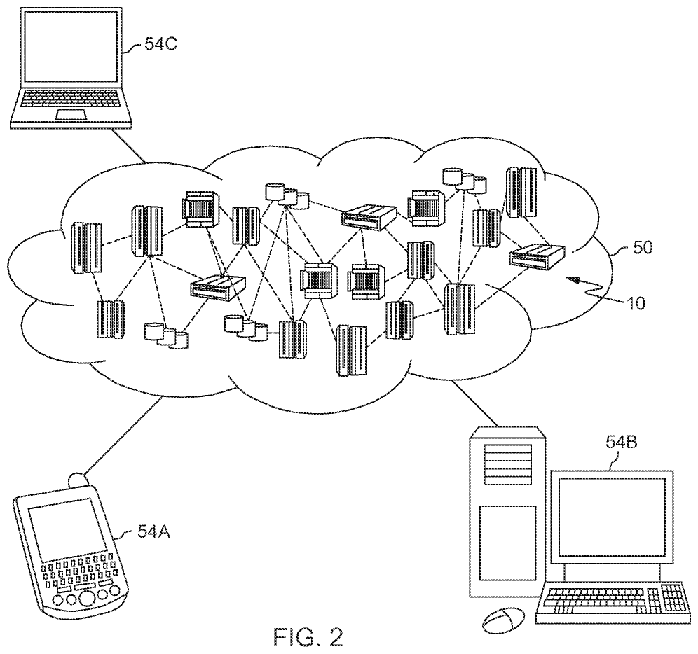

Referring now to FIG. 2, illustrative cloud computing environment 200 is depicted. As shown, cloud computing environment 200 comprises one or more cloud computing nodes 100 with which local computing devices used by cloud client, such as, for example, personal digital assistant (PDA) or cellular telephone 54A, desktop computer 54B, laptop computer 54C, and/or the like may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 200 to offer infrastructure, platforms and/or software as services for which a cloud client does not need to maintain resources on a local computing device. It is understood that the types of computing devices 54A-N shown in FIG. 2 are intended to be illustrative only and that computing nodes 100 and cloud computing environment 200 can communicate with any type of computerized device over any type of network and/or network addressable connection (e.g., using a web browser).

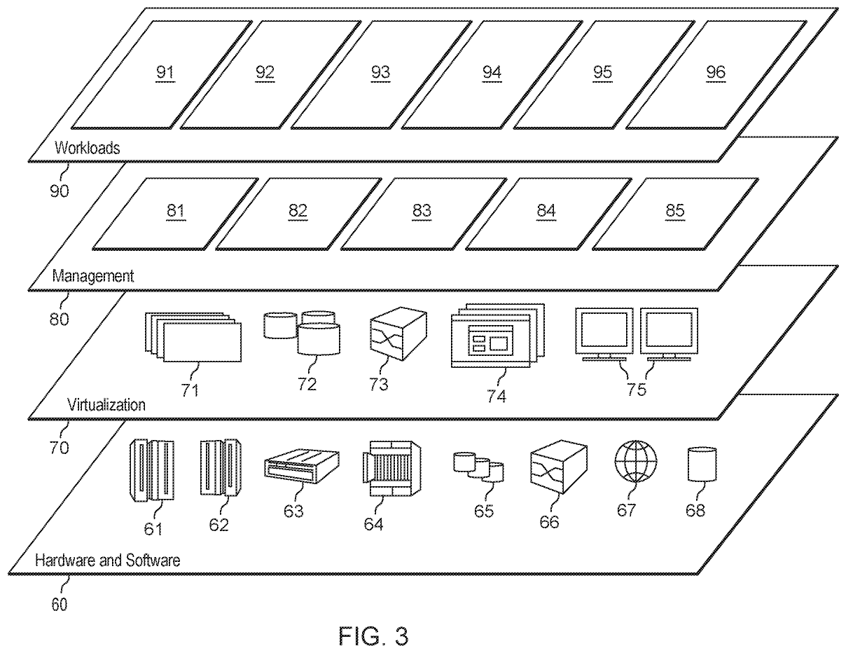

Referring now to FIG. 3, a set of functional abstraction layers provided by cloud computing environment 200 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud users and tasks, as well as protection for data and other resources. User portal 83 provides access to the cloud computing environment for users and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and parking space selection 96.

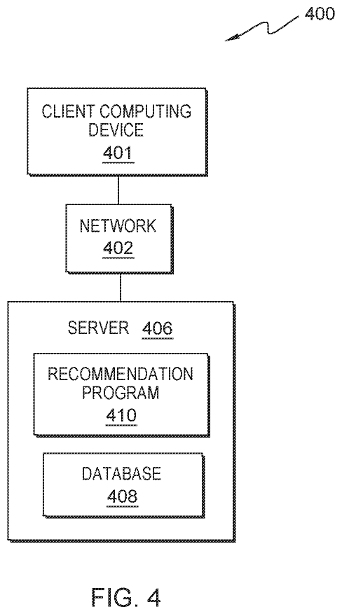

Referring back to FIG. 1, the Program/utility 40 may include one or more program modules 42 that generally carry out the functions and/or methodologies of embodiments of the invention as described herein. Specifically, the program modules 42 may monitor real-time the creation of the options which are provided to the customers, the selection process and final ordering of the option(s), and fulfillment of the orders to the client. Other functionalities of the program modules 42 are described further herein such that the program modules 42 are not limited to the functions described above. Moreover, it is noted that some of the modules 42 can be implemented within the infrastructure shown in FIGS. 1-3. For example, the modules 42 may be representative of an option creation server as shown in FIG. 4.

FIG. 4 depicts a block diagram of a computing environment 400 in accordance with one embodiment of the present invention. FIG. 1 provides an illustration of one embodiment and does not imply any limitations regarding the environment in which different embodiments maybe implemented.

In the depicted embodiment, computing environment 400 includes network 402, user computing device 404 and server 406. Computing environment 400 may include additional servers, computers, or other devices not shown.

Network 402 may be a local area network (LAN), a wide area network (WAN) such as the Internet, any combination thereof, or any combination of connections and protocols that can support communications between client computing device 404, and server 406 in accordance with embodiments of the invention. Network 402 may include wired, wireless, or fiber optic connections.

Client computing device 404 may be a management server, a web server, or any other electronic device or computing system capable of processing program instructions and receiving and sending data. In some embodiments, client computing device 404 may be a laptop computer, tablet computer, netbook computer, personal computer (PC), a desktop computer, or any programmable electronic device capable of communicating with server 406 via network 402. In other embodiments, client computing device 404 may represent a server computing system utilizing multiple computers as a server system, such as in a cloud computing environment. In another embodiment, client computing device 404 represents a computing system utilizing clustered computers and components to act as a single pool of seamless resources. In other embodiments, client computing device 404 may include any combination of Recommendation program 410 and database 408. Client computing device 404 may include components, as depicted and described in further detail with respect to FIG. 3.

Server 406 may be a management server, a web server, or any other electronic device or computing system capable of processing program instructions and receiving and sending data. In other embodiments server 406 may be a laptop computer, tablet computer, netbook computer, personal computer (PC), a desktop computer, or any programmable electronic device capable of communicating via network 402. In one embodiment, server 406 may be a server computing system utilizing multiple computers as a server system, such as in a cloud computing environment. In one embodiment, server 406 represents a computing system utilizing clustered computers and components to act as a single pool of seamless resources. In the depicted embodiment database 408 and recommendation program 410 are located on server 406. Server 406 may include components, as depicted and described in further detail with respect to FIG. 1.

Recommendation program 410 operates to perform an analysis of the patient's inputs to assist in determining if they are having an episode or relapse of their health issue(s). In the depicted embodiment, Recommendation program 410 utilizes network 402 to access the server 406, and communicates with database 408. In one embodiment, Recommendation program 410 resides on client computing device 404. In other embodiments, Recommendation program 410 may be located on another server or computing device, provided Recommendation program 410 has access to database 408.

Database 408 may be one or more repositories that may be written to and/or read by the program 40 or program modules 42 as well as the client computing device 404. The database 408 may include relational data and include numbers of tables, records, links, business products, product information, client information, and the like. In one embodiment, database 408 is a database management system (DBMS) used to allow the definition, creation, querying, update, and administration of a database(s). In the depicted embodiment, database 408 resides on server 406. In other embodiments, database 408 resides on another server, or another computing device, provided that database 408 is accessible to recommendation program 410.

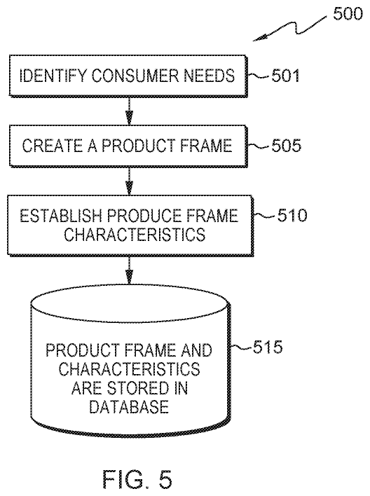

FIG. 5 depicts a flowchart 500 of the operational steps taken by a program, in accordance with an embodiment of the present invention. The method(s) and associated process(es) are now discussed, over the course of the following paragraphs, in accordance with one embodiment of the present invention.

The recommendation program 410 commences the process of providing the goods and services to the consumer by identifying the consumer's needs 501. The recommendation program 410 is able to analyze what goods and services the consumers want/need and determines possible product categories for which product frames could be created by the recommendation program 410 to assist the producers. This step involves various forms of artificial intelligence, computer learning, and potential third-party software/systems to assist in the collection of consumer data and consumer needs.

The recommendation program 410 then creates a set of product frames 505 within the categories to provide a general solution to a consumer's needs, requests, or desires. For example, in the product category meals, the product frame may be breakfast, lunch, or dinner. In another example the product category may be outfits, and the product frames are casual, business casual, and formal. The product frames are created by the recommendation program 410 observing, researching, and analyzing through both the recommendation program 410 direct access through database 408 and the network 402, but also through the use of artificial intelligence, computer learning technologies, and various data mining processes to determine different frames within the categories.

The recommendation program 410 then applies a set of characteristics 510 to the product frames. The characteristics set forth the number of elements which are needed to complete the product frame, the type of elements which are able to populate the product frame, the restrictions which are applied to the product frame, and other characteristics which are used to assist the producer in creating the product items and the consumer to allow them to locate the desired product item. For example, where the product frame is related to outfits, the product frame characteristics may be setting forth the type of outfit (formal, business casual, etc.). The number of product elements which are required to complete the product frame, for example, shoes, pants, shirt, jacket, hat. In another embodiment, the characteristics may be a description of the product frame, search terms, and the like to assist the recommendation program 410 to be able to provide a consumer with search results based on their search terms.

In some embodiments, the recommendation program 410 creates product categories for each and every product or service within the system. This process is not limited to just one good or service, but to any combination of goods or services which a consumer may need. For example, this may include a category for meals or outfits. The recommendation program 410 creates a set of product categories. The product categories provide large groupings of like product frames. The categories are created by the recommendation program 410 observing, researching, and analyzing through both the recommendation program 410 direct access through database 408 and the network 402, but also through the use of artificial intelligence, computer learning technologies, and various data mining processes to determine different categories of goods.

In some embodiments, the product frames are stored 515 in the database 408 manually. In other embodiments, the product frames may be generated by the recommendation program 410 based on machine learning or artificial intelligence that monitor, analyze, and decipher consumers needs and behaviors and buying patterns. This analysis and monitoring may be performed by a third-party software or an integrated module within the recommendation program 410 system.

The recommendation program 410 then creates product element templates within the product frame to generate a complete solution to the consumer's needs or request. For example, the product elements for a product frame of “business casual” may include shoes, socks, pants, belt, shirt, sweater, and hat. In another embodiment, the product elements for a “dinner” may include appetizer, main dish, sides, dessert, drinks, and time. The elements are created by the recommendation program 410 observing, researching, and analyzing through both the recommendation program 410 direct access through database 408 and the network 402, but also through the use of artificial intelligence, computer learning technologies, and various data mining processes to determine different elements for the frames.

The recommendation program 410 then creates a set of product parameter templates which are associated with the product element to generate sufficient details about the product element. For each product element, there are a set of product parameters. These parameters are the most specific set of descriptors to limit the products or services which can fit within the product frame. For example, with the “business casual” outfit, the parameters may be size, color, style, or the like. The recommendation program 410 is able to use the analyzed data to determine colors that match or remove products that do not meet the specific consumer's limitations or factors. In the example with the meal, this may include a number of dishes, the type of dishes, if the meal is vegan or vegetarian, the specific time for deliver, or other factors which reflect consumer preferences. The parameters are created by the recommendation program 410 observing, researching, and analyzing through both the recommendation program 410 direct access through database 408 and the network 402, but also through the use of artificial intelligence, computer learning technologies, and various data mining processes to determine different parameters for the elements.

The categories, frames, item (described below), elements, and parameters are all stored 515 within the database 408 and used for references for the recommendation program 410 when generating new product frames or modifying old product frames. The recommendation program 410 is able to review previously created frames and either generate variations of these, replace outdated frames, or create entirely new frames based on newly discovered information and data. These product frames are used to create the templates which the producers use when preparing their products for the consumer. The recommendation program 410 provides a system where the producers are required to present their goods or services in a similar, and easily manageable format for the consumer, so to improve the purchasing process for the consumer and to provide a single solution to a consumer's request.

The recommendation program 410 is designed to provide highly specialized and specific set of product frames to the consumer based on their search terms, location, search history, and additional information, including, but not limited to, other consumer's search history and terms.

In some instances, there may be multiple product frames which meet the basic requirement of the consumer's request.

In a first example of this process, a consumer may be a parent looking for a healthy meal for their family. The meal is a combination of dishes (e.g. entrees, sides, desserts, etc.), the number of serving needed (number of people the meal feeds), the time of delivery of the meal, the price of the meal, and the availability of the meal. The recommendation program 108 identifies the consumers' needs of having a complete meal prepared, and the parameter of the meal. The recommendation program 108, the generates a number of product frames that fit these needs. The product frames provide for a varying number of entrees, sides, desserts, how many servings per dish, how many people the meal feeds, the price of the meal, and a typical delivery window for the meal. This product frame is what is provided to the producer when they begin to create their product items.

In another example, the recommendation program 108 identifies, a consumer as being a business professional looking to find an outfit to wear to work. The recommendation program 108 determines the parameters of what a business casual outfit includes (e.g. shoes, belt, socks, pants, shirt, undershirt, tie, blazer, etc.) and additional required or optional aspects of the outfit based on the recommendation program's 108 findings and analysis. The recommendation program 108 then creates the product frame for an outfit. There may be varying product frames constructed based on the level of completeness of the outfit. For example a first product frame may have shoes, belt, socks, jeans, and a crew neck shirt. A second product frame many have shoes, belt, socks, slacks, button down shirt, blazer, and tie. Due to the variety in business casual based on the company and geographical location and norms, the recommendation program 108 is able to create numerous product frames for the producer to start from when creating their product items.

With a multitude of consumers and a vast array of the needs of these consumers, product frames may be created at a substantially continuous basis, and out date product frames may be removed from circulation. The recommendation program 108 is able to constantly analysis and learn what the consumer needs are to generate the product frames to assist the producers with providing product items that meet the consumer's needs and are likely to increase the percentage of completed sales of the goods.

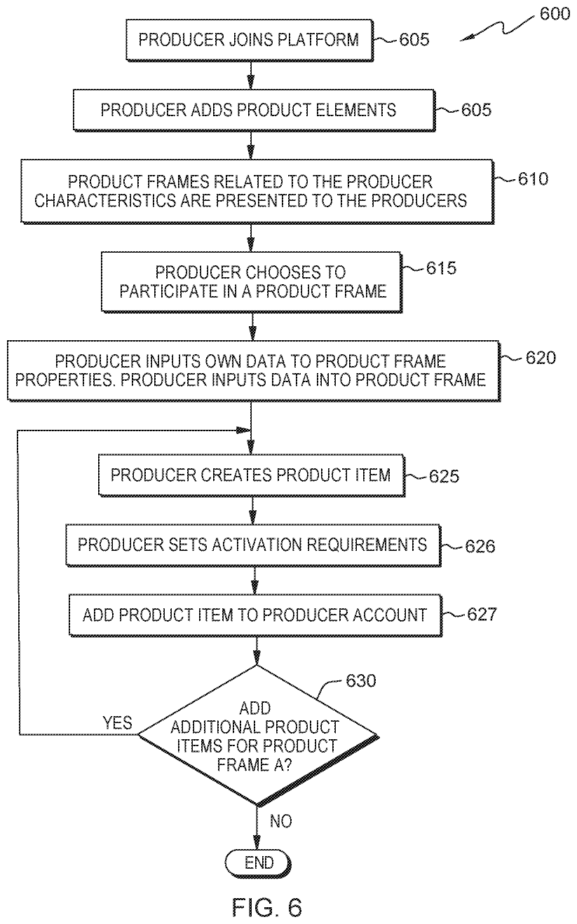

FIG. 6 depicts a flowchart 600 of the operational steps taken by the program, in accordance with an embodiment of the present invention. The method(s) and associated process(es) are now discussed, over the course of the following paragraphs, with extensive reference to FIG. 2, in accordance with one embodiment of the present invention.

The recommendation program 410 provides the producers(s) with a structured and established platform to present their products to consumers. The producer is provided with an account 605, and the producer (or the platform) can set limitations on their account. These limitations may be hours of operation, availability, limitation in number of goods or services offered on any given day or the like.

The producer adds 606 their product elements into the system. This may be a manual entry of each product item, or may be an automated process. Each product element that is uploaded or introduced into the system is categorized and identified based on a set of details associated with the product element. The identification provides for a class or groups which the product element is associated with. For example, a product element for a blue button-down shirt may be grouped with “male clothing tops” “casual clothing” “formal clothing” “long sleeve male tops” and “blue shirts.” In other example, product element in food marketplace could be “Steamed broccoli” grouped under “Side dish”, “vegan”, “vegetarian”, “gluten-free”, “low-fat”, “low-carb”, etc. The details about the product element and its parameters may be input by the producer, or the recommendation program 408 may automatically extract this data from various types of media related to the product element.

In some embodiments, this assists recommendation program 410 to combine various products based on these details to assist in the generation of automatic product frames. Each group is designed and created based on the product elements and the available product frames. This data may be extracted from the producer's input data, data extracted from images or illustrations of the product element, or previously collected and compiled data by the recommendation program 410. The registration of the group or class for each product element is stored in database 408. In some embodiments, each group or class has a predetermined nomenclature for the products within that class.

In one embodiment, the producer can view all available product frame(s) that they could participate in 610. this participation requirement maybe set by the producer's account type or uploaded/input product elements. The producer then selects 615 one or more product frames they want to participate in/with. After the selection, the producer is able to manipulate and customize the product frame within the limits of the system. This may include creating 620 their own descriptions of the product frame and applying producer specific settings and limitations/restrictions. For example, a producer may add values for their pickup address, order cutoff times, daily capacity for this product frame. In some embodiments, after a producer is enrolled into participating in a product frame, may they can manually create 625 product items (complete sellable unit). The product item is what is selected by the consumer and is comprised of a set of product elements (sellable components which make up the product item). The producer is able to set 626 various activation requirements or other types of requirements to the product item. For example, for meals that are available during certain times of the day or days of the week. The producer is able to set their restrictions so that the product item is only available to consumers for deliver during these times. This may also restrict when the consumer is able to view the product item. For example, if the product item is not set to an “active” state, it remains “hidden” to the consumers until the producer “activates” the product item. A product item is the instantiation of the product frame that is created by the producer that is a able to be purchased by a consumer. Once the producer creates the product item and sets the activation requirements, the product item is added to the producer account 627 and is released to the consumers upon the completion of the activation requirements. A producer can also set the activation requirement after the product items has been added to its account.

In some instances, a producer may want to create 630 more than one product item for the product frame if they have, for example, multiple different dinner options. The recommendation program 410 allows the producer to create product item(s) that adhere to the limitations and restriction set forth in the product frame. In some embodiments, the producer is able to manipulate a product item to have different settings to one product item.

The producer has the option to manually input their product elements before creating product items or during creating product items and set the product parameters as well. This will include the product parameters, the product element types, the product elements which comprise the product item and any additional information such as pricing and availability of the producer. This may be a completely free system or may have various factors or details which are set by the recommendation program 410 to create a road map for the producer to follow. In some embodiments, the recommendation program 410, is able to collect this data and automatically populate all the product item and elements with the producer's products would fit within a product frame. In additional embodiments, the producer may be required to provide all of the product elements for a product item. The recommendation program 410 stores this data in database 408. In some embodiments, the producer is able to generate a new or amended product item if no current product items accomplish what the producer is looking to present to the consumers. This would require the producer to populate the product elements and parameters for the product frame.

For example, a producer who is a chef/restaurant can select to participate in one or more predefined product frames, such as Family Dinner, Weekend Brunch. The producer can select Family Dinner and set limits or requirements for the system and consumer to adhere to regarding the purchasing of the product items. This may include the maximum number of orders, cutoff time for order, delivery window, price, and the like. To create a menu in Family Dinner (product frame), the producer selects various dishes (product elements) to complete the menu and then assigns parameters such as cuisine type, price, diet tags, and the like. Once completed the product frame becomes a product item under the producer's account. The producer can then create additional product items of the specific product frame. If for example the producer has multiple different Family Dinner options, they can create a product item for each one.

When the producer has entered a product element, the recommendation program 410 is able to monitor this process and provide potential recommendations This may be in the form of providing a product frame or a product frame template to assist the producer in generating the product item based on the recommendation programs 410 analysis. In embodiments where the platform is generating a custom product frame, the recommendation program 410 many provide an already create product frame(s), additional product frame details, suggested elements or parameters to include based on the previously collected and analyzed data to assist the platform. This may assist the platform in creating a product frame which is more appealing to a consumer. In one example, the product frame is for men's wedding outfit as shoes, suit, shirt, tie, pocket square, watch, and socks. The producers cannot modify these product frame requirement but can provide their own terms of fulfilling product items in this product frame. This may include “delivery options” or “alterations” which are additional features or services the producer may offer.

The recommendation program 410, collects the data input by the producers to develop, create, and amend past and future product frames. Through an analysis of the producers generation of the product items, the recommendation program 410 is able to determine when new product frames need to be created to assist the producers, or to expand the array of products or services offered through the platform. The recommendation program 410, also collects data related to the product element (and product parameters by default) that the producer uses to complete the product items. Through this collection of data, the recommendation program 410 is able to determine if the product elements would be suitable to be placed in a different product frames. In some embodiments, the recommendation program 410 is able to generate product items based on the input product elements of the producer. In certain product categories, such as clothing and various activities (e.g. camping and various activities) this generation of product items may provide additional exposure and potential sales of goods based on the recommendation programs 410 understanding of buyers trends and buying habits.

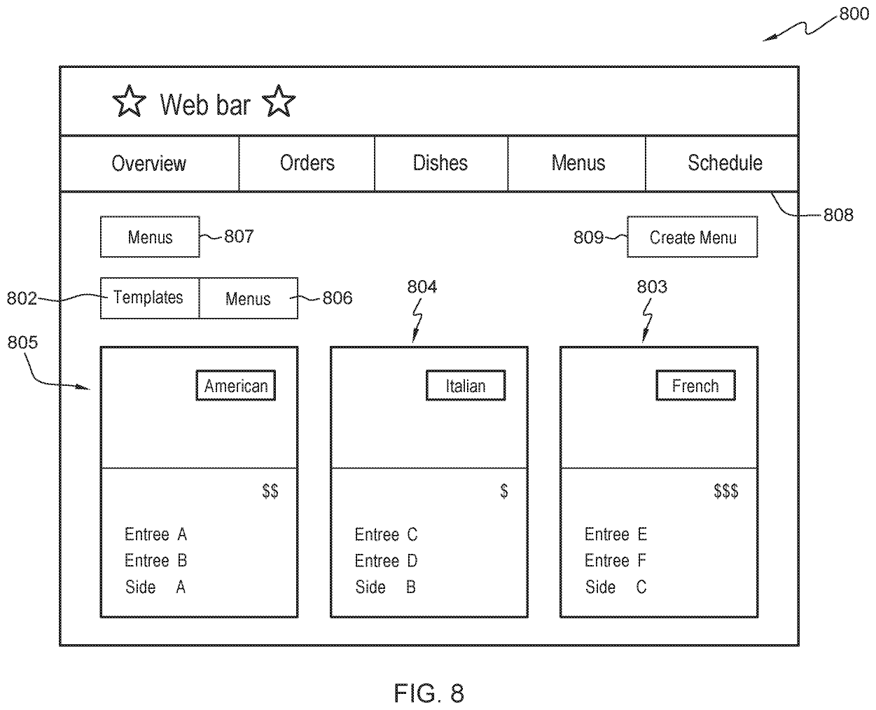

In some embodiments, a producer's type or product type may alter the design of the user interface to accommodate the specific producer. For example, a producer who is a chef may have a user interface that provides for product templates for breakfasts, lunches, dinners, and the like. The user interface is adjusted and modified to accommodate the producer type to create a more user friendly experience. As shown in FIG. 8 which shows an illustration of a user interface in one embodiment. In additional embodiments, a user interface for a producer type who is designed would have templates for, for example, casual outfits, business casual outfits, formal outfits, and the like.

FIG. 8 illustrates a potential producer interface, in accordance within one embodiment of the present invention. In the depicted user interface 800, the producer is exposed to a number of options. Tool bar 808 provides a variety of options for the producer to select between, along with icon 809 which allows the producer to create a product item for the product frame. Product items 803, 804, and 805 show different versions of a product frame. The product item contains two entrees and one side, and the producer had created three (3) product items, one for American food, one for Italian food, and one for French food. They each include different product elements (e.g. entrees and sides). This is for exemplary purposes and the producer can reuse the product elements as they desires to create the variety of product items. Icon 806 provides the producer access to their other product items for this product frame and potentially other product frames as well. Icon 802 provides the producer to access a template(s) for the product frame to assist them with the creation of the product item. Icon 807 provides the producer with access to their entire menu, which may include numerous product items for a variety of product items. This interface is dynamic and is able to adjust based on the producer type.

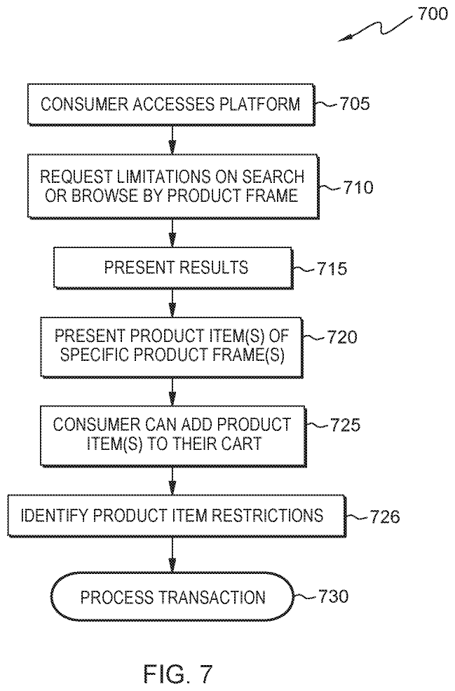

FIG. 7 depicts a flowchart 700 of the operational steps taken by the program, in accordance with an embodiment of the present invention. The method(s) and associated process(es) are now discussed, over the course of the following paragraphs, in accordance with one embodiment of the present invention.

The recommendation program 410 processes all the received data from the producer and the proceeded data collected to present the product frames and product items to the consumers. The consumer accesses the platform 705 through a web or application based service. The consumer inputs their search requirements 710 and the recommendation program 410 presents 715 the consumer with various product frames, product items, or product elements which meet their search criteria. In some embodiments, the consumer is able to browse product items based on a selected or identified product frame(s). When browsing the consumer is selecting a product frame and all of the product items within that frame are presented to the consumer. In some embodiments, the consumer is able to refine this by inputting search terms, or the recommendation program 410 is able to refine the results through various restrictions on the results. For example, providing only restaurants within a predetermined delivery radius to the consumers location. In some embodiments, the recommendation program 410 request information from the consumer to limit the product items based on their location, availability, and the like. These limitations may also be based on the consumer's desires as well. For example, if the consumer is looking for a dinner, the recommendation program 410 may request the consumer to identify days of the week, time frames, or the like to remove product items which are not relevant to the consumer. The consumer can further search (or filter) byproduct element, or even search based on product parameters. The recommendation program 410 provides the consumer with the most accurate and relevant results 720 to the consumer based on the search restrictions and the availability of the product items within the relevant product frames and the availability of the product items. Consumer can also browse Product items based on Product frames. The consumer than is able to add the product item(s) to their cart 725. The recommendation program 410 may use third party technology to complete the search and analysis of the consumer's request and the stored data. The recommendation program 410 identifies the product item restrictions 726 set forth by the producer and applies these restrictions. For example, if a consumer adds a product item from a first producer which is restricted to mornings on weekdays, and a second product item from a second producer which is restricted to events on weekends. These restrictions are applied to only the specific product item within the consumers “cart.” In some embodiments, the recommendation program 410 identifies when there are overlaps or conflicts with the product items. As the product item is purchased 730 by consumers, certain producers may have a limit to how many product items they offer based on predetermined limitations (e.g. number of meals made per day, delivery window, etc.), and the recommendation program 410 is able to update the available product items based on the allotted number of purchases and availability of the product item.

The request is based on the goods/services requests. For example, if the consumer is looking for a meal, geographic information is needed to find local producers within a predetermined location or area or within the producer's delivery radius or area. If the consumer is looking for an outfit, their size, skin tone, event type, or the like is relevant and required to allow the recommendation program 410 to process the present set of product frames and provide the consumer with the most accurate results. In additional embodiments, where a request does not have a defined product item, a similar or like product item is presented to the consumer.

Based on the consumer's request, the program provides to the consumer the product frame(s) which are related to and associated with their request. In some embodiment, product items are shown to the consumer to fulfill their request. For example, if the consumer is looking for an outfit, multiple different complete outfits (product item) are presented to the consumer or the consumer may be presented with a variety of product elements which fit within the larger product frame. The consumer is able to select the various product elements of the product item to gain access to the producer, or other product items which contain that one or more product element

This is advantageous for the recommendation program 410 to generate new product frame or variants of product frames based on consumer specific desires and requests. The platform is assisting the recommendation program 410 with market research and product innovation; which benefits the consumer to achieve a specific look or style they are interested in accomplishing without needing expertise or resources of their own. This information is then able to be relayed to the producers to adjust or alter the product elements of the product item to maximize sales.

In some embodiments, upon the selection of a product frame or a product items from the product frame, the recommendation program 410 provides additional information for the consumer about the selected product or service. This may include the specific producer of the product items or origin of product elements in the product items if it comprised of more than one producer. The consumer may be able to purchase specific product element, the product item as a whole, or a combination of the like. In some embodiments, a one click purchase of the entire product item is provided to the consumer.

In some embodiments, the consumer may create a custom product item based on the product frame design and place a single order comprising of any product items, regardless of product frame or producer they are from. Delivery Status of each product item can be tracked separately. The recommendation program 410 records and stores this data to provide additional information for the producers, and for the generation of product frames or product items based on the available product elements available on the platform.

The present invention may incorporate various pricing adjustments based on demand forecasting. This may cause prices of products frames or product items to be adjusted in real time based on collected or calculated forecast data. This may affect the presentation of the product frames to the consumer (step 420) The sales information returned from each completed transaction, real time public and private sales information, catering not only to individual buyers, but, more importantly, to producers. For example, in response to queries from individual buyers or competitors, the query bridge of the present invention may easily be configured to deliver public information such as pricing and product descriptions. This can include demand for delivery based on time, location, local events, and other factors which affect customers desire to have products delivered. For queries generated within a selling channel (i.e., by a manufacturer, distributor or retailer or by their sales systems), private information relating to each product such as inventory, inventory projections, numbers sold, margins, etc., may be easily and automatically collected. Such information can be used for forecasting inventory, pricing, planning promotional activities (e.g., instant coupons, auctioning and rebate programs), and production planning, for example.

In some embodiments, the present invention collects data related to grouping of product frames and items selected by a consumer based on previous selections by the same consumer and which is used most recently to assist in providing search results to the consumers inquiries. These groupings of product frames or elements are based on a consumer latest behavior history and in some embodiments consumers of similar demographics, locations, and similar search histories.

Consumers can save favorite producers and directly access only product items from those producers

Consumers can first search and select first the producers—based on some parameters, such as location or characteristics of their product elements and product items.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A method for grouping products, the method comprising:
identifying, by one or more processors, a product frame, wherein the product frame is comprised of a set of criteria;
selecting, by one or more processors, the requirements for the product frame based on the set of criteria;
receiving, by one or more processors, a set of product elements;
grouping, by one or more processors, the set of product elements within the product frame's set of criteria, wherein the product item is created;
storing, by one or more processors, the product item.

2. The method for grouping products of claim 1, wherein the product elements are assigned, by one or more processors, a set of product parameters.

3. The method for grouping products of claim 1, wherein the set of criteria for the product frame is associated with predetermined limitations which are applied to the product frame.

4. The method for grouping products of claim 1, further comprising, generating, by one or more processors, a set of product frames.

5. The method for grouping products of claim 1, further comprising, providing, by one or more processors, dynamic pricing of the product item based on a set of factors.

6. The method for grouping products of claim 1, further comprising, generating, by one or more processors, a unique product frame based on the analysis of the existing product frames.

7. The method for grouping products of claim 6, further comprising, populating, by one or more processors, the product frame with a set of product elements based on the known set of criteria for the product frame and the set of product elements parameters.

8. A computer program product for grouping products, the computer program product comprising:
one or more computer readable storage media and program instructions stored on the one or more computer readable storage media, the program instructions comprising:
program instructions to create a product frame, wherein the creation of the product frame includes assigning a set of criteria to the product frame;
program instructions to receive a set of product elements, wherein the product elements are assigned a set of parameters;
program instructions to identify which product elements meet the set of criteria of the product frame based on the product element's set of parameters;
program instructions to group the approved identified product elements within the product frame, wherein a product item is created;
program instructions to store the product item.

9. The computer program product of claim 8, further comprising, program instructions to compare the created product frame to a set of stored product frames, wherein it is determined if the created product frame is unique.

10. The computer program product of claim 9, wherein if it is determined that the created product frame is unique, permitting the creation of the product frame.

11. The computer program product of claim 8, further comprising, program instructions to generate a user interface.

12. The computer program product of claim 8, wherein the product item are assigned a second set of criteria.

13. The computer program product of claim 12, wherein the second set of criteria when compared to a set of requirements further comprise, program instructions to dynamically adjust a price of the product item.

14. The computer program product of claim 8, further comprising, program instructions to monitor a consumer and determine the product items viewed by the consumer and determine the searching patterns of the user to provide potential unique product frames.

15. A computer system for creating purchasable goods, the system comprising:
one or more computer processors, one or more computer readable storage media, and program instructions stored on the one or more computer readable storage media for execution by, at least one of the one or more processors, the program instructions comprising:
program instructions to generate a set of product frames, where each product frame has a set number of product element identifications;
program instructions to receive a set of product elements, wherein each product element has a set of product parameters;
program instructions to identify a group of product frames based on the type of product elements or the product parameters;
program instructions to present the identified group of product frames;
program instructions to identify if the set number of product element identifications can be fulfilled by the received set of product elements, wherein it is determined that the set number of product elements identifications cannot be fulfilled;
program instructions to locate product elements that fulfill the product element identifications which are unfulfilled;
program instructions to confirm the completion of the product element identifications for the product frame;
program instructions to publish the product frame as a product item.

16. The computer system of claim 15, further comprising, program instructions to generate a unique user interface based on a set of features of the user based on a set of uploaded product elements.

17. The computer system of claim 15, further comprising, program instructions to apply a set of restrictions on the product item based on the product elements.

18. The computer system of claim 15, wherein the product frame has a set of criteria, wherein the criteria is based on the product elements.

19. The computer system of claim 15, further comprising, program instructions to customize the product frame, wherein the customization generates a unique product frame.
